(19) United States
(12) Patent Application Publication
(10) Pub. No.: US 2025/0041853 A1
(43) Pub. Date: Feb. 6, 2025

(54) COMPACT MICRO-OPTICAL CAVITY ARRAYS

(71) Applicants: Georgia Tech Research Corporation, Atlanta, GA (US); Space Dynamics Laboratory, North Logan, UT (US); Air Force Research Laboratory, Wright-Patterson Air Force Base, OH (US); Universities Space Research Association, Washington, DC (US)

(72) Inventors: Chandra Raman, Atlanta, GA (US); Alexandra Crawford, Atlanta, GA (US); Jacob Williamson, Atlanta, GA (US); Spencer E. Olson, Wright-Patterson Air Force Base, OH (US); Robert H. Leonard, North Logan, UT (US); Meagan Plummer, Washington, DC (US); Matthew Marshall, Washington, DC (US)

(21) Appl. No.: 18/794,675

(22) Filed: Aug. 5, 2024

Related U.S. Application Data
(60) Provisional application No. 63/530,844, filed on Aug. 4, 2023.

(51) Int. Cl. B01L 3/00

(52) U.S. Cl. CPC B01L 3/502715; B01L 2300/168; B01L 2400/0439

(57) ABSTRACT

An exemplary embodiment of the present disclosure provides a method of sensing at least one characteristic of an analyte comprising: flowing media with the analyte through one or more microcavities; energizing the microcavity; and sensing at least one of the characteristics of the analyte via interrogation of the energized microcavity. Each of the one or more microcavities can comprise: a first mirror on a first planar surface; a second mirror on a second planar surface opposing the first planar surface; and at least one spacer between the first and second mirrors. The first mirror, second mirror, and at least one spacer can define a channel having an inlet and an outlet. The first and second mirrors can be positioned between the inlet and outlet.

### CROSS-REFERENCE TO RELATED APPLICATIONS

This application claims the benefit of U.S. Provisional Application Ser. No. 63/530,844, filed on 4 Aug. 2023, which is incorporated herein by reference in its entirety as if fully set forth below.

### GOVERNMENT LICENSE RIGHTS

This invention was made with government support under Agreement No. FA9453-21-2-0064, awarded by the Air Force Research Laboratory. The government has certain rights in the invention.

### FIELD OF THE DISCLOSURE

The various embodiments of the present disclosure relate generally to systems and methods for optical sensing of a sample, and more particularly to compact micro-optical cavity arrays.

### BACKGROUND

Cavity absorption spectroscopy (and the related technique, cavity ringdown spectroscopy) is a known method for optical sensing of a sample. The basic principle is that light traverses the cavity multiple times before it exits, therefore enhancing the interaction between the sample and the electromagnetic field (see, FIG. 1). An advantage of utilizing a cavity is that it greatly increases the effective path length d_{eff}:

$${d}_{eff} = \frac{d}{1 - R} \qquad ( 1 )$$

where d is the mirror spacing and R the mirror reflectivity. The condition of highly reflective cavity mirrors, R→1, allows d_{eff}>>d. The basic quantity determining the sensitivity is the optical depth:

$$OD = {α Nd}_{eff} \qquad ( 2 )$$

which is the amount of light absorbed by the sample. A good sensor seeks to maximize the OD for a given analyte concentration N and sample-specific extinction coefficient α. Thus, an increase in d_{eff} greatly improves the sensitivity to a given quantity of analyte. Macroscopic cavities such as shown in FIG. 1 use mirror separations of the order of 1 meter and are highly sensitive laboratory instruments. However, due to their high susceptibility to mirror vibrations they are not easily transportable. Accordingly, there is a need for improved devices for cavity absorption spectroscopy.

### BRIEF SUMMARY

An exemplary embodiment of the present disclosure provides a method of sensing at least one characteristic of an analyte comprising: flowing media with the analyte through one or more microcavities; energizing the microcavity; and sensing at least one of the characteristics of the analyte via interrogation of the energized microcavity. Each of the one or more microcavities can comprise: a first mirror on a first planar surface; a second mirror on a second planar surface opposing the first planar surface; and at least one spacer between the first and second mirrors. The first mirror, second mirror, and at least one spacer can define a channel having an inlet and an outlet. The first and second mirrors can be positioned between the inlet and outlet.

In any of the embodiments disclosed herein, the media can be gaseous.

In any of the embodiments disclosed herein, the media can be in liquid form.

In any of the embodiments disclosed herein, the spacer can have a thickness of 50 microns to 4 mm.

In any of the embodiments disclosed herein, the one or more microcavities can comprise a first microcavity and a second microcavity, wherein the first and second microcavities are coplanar.

In any of the embodiments disclosed herein, the first microcavity can have a first width, a first height, and a first length, the second microcavity can have a second width, a second height, and a second length, and at least one or the first width, first height, and first length can be different than the second width, second height, and second length, respectively.

In any of the embodiments disclosed herein, the one or more microcavities can further comprises a third microcavity and a fourth microcavity. The third and fourth microcavities can be coplanar. The first and second microcavities can be not coplanar with the third and fourth microcavities.

In any of the embodiments disclosed herein, the first mirror can have a concave inner surface.

In any of the embodiments disclosed herein, the concave inner surface of the first mirror can have a radius of curvature of 300 microns to 4 mm.

In any of the embodiments disclosed herein, the second mirror can have a planar inner surface.

In any of the embodiments disclosed herein, energizing the microcavity can comprise lighting the microcavity, such that light reflects between each of the first and second mirrors.

In any of the embodiments disclosed herein, sensing can comprise a comparison of light entering the microcavity and light exiting the microcavity.

In any of the embodiments disclosed herein, the at least one spacer can comprise a piezoelectric material, and the method can further comprise applying a drive signal to the piezoelectric material to alter a thickness of the at least one spacer.

Another embodiment of the present disclosure provides a microcavity system for sensing a characteristic of an analyte. The microcavity system can comprise one or more microcavities. Each microcavity can comprise: a first planar surface comprising a first mirror; a second planar surface opposing the first planar surface, the second surface comprising a second mirror; and at least one spacer positioned between the first and second surfaces. The first and second planar surfaces and the at least one spacer can define a channel having an inlet receive the analyte and an outlet configured to eject the analyte.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1. provides a schematic of a conventional macroscopic cavity for cavity absorption spectroscopy.

FIG. 2 provides a schematic of a microcavity system, in accordance with some embodiments of the present disclosure.

FIGS. 3A-B provide top and side views, respectively, of a schematic of a microcavity system, in accordance with some embodiments of the present disclosure.

FIGS. 4A-B provide schematics of microcavity array systems, in accordance with some embodiments of the present disclosure.

### DETAILED DESCRIPTION

Although preferred exemplary embodiments of the disclosure are explained in detail, it is to be understood that other exemplary embodiments are contemplated. Accordingly, it is not intended that the disclosure is limited in its scope to the details of construction and arrangement of components set forth in the following description or illustrated in the drawings. The disclosure is capable of other exemplary embodiments and of being practiced or carried out in various ways. Also, in describing the preferred exemplary embodiments, specific terminology will be resorted to for the sake of clarity.

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

As used in the specification and the appended claims, the singular forms “a,” “an” and “the” include plural referents unless the context clearly dictates otherwise.

Also, in describing the preferred exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another exemplary embodiment includes from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, member, particle, or method step is present in the composition or article or method, but does not exclude the presence of other compounds, materials, particles, method steps, even if the other such compounds, material, particles, method steps have the same function as what is named.

Mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The materials described as making up the various members of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

FIGS. 2-4B provide various exemplary microcavity systems of the present disclosure. As those skilled in the art would appreciate, however, the disclosure is not limited to only those embodiments shown in the figures. Rather, the figures provide exemplary implementations, and the present disclosure should be read as incorporating many other designs not shown in the attached figures.

As shown in FIG. 2, an exemplary embodiment of the present disclosure provides a microcavity system for sensing a characteristic of an analyte. The microcavity system can comprise one or more microcavities. For example, as shown in FIG. 2, the microcavity system comprises two microcavities. Each microcavity comprises a first planar surface (e.g., substrate) 205 and a second planar surface 210 opposing the first planar surface. Each of the planar surfaces can comprise a mirror (e.g., micromirror) 206A-B 207A-B. As shown in FIG. 2, in some embodiments, opposing mirror pairs (e.g., 206A 207A) can be spaced directly apart from each other such that light reflects back and forth between the mirrors. The planar surfaces 205 210 can be separated by one or more spacers 215A-B. the planar surfaces 205 210 in combination with the one or more spacers 215A-B can define one or more channels 220. The channel 220 can have an inlet and outlet (not shown in FIG. 2). The inlet can receive media containing an analyte to be analyzed such that the media/analyte pass through the channel where light is reflected between the mirrors 206 207. The media/analyte can then exit the channel 220 through the outlet.

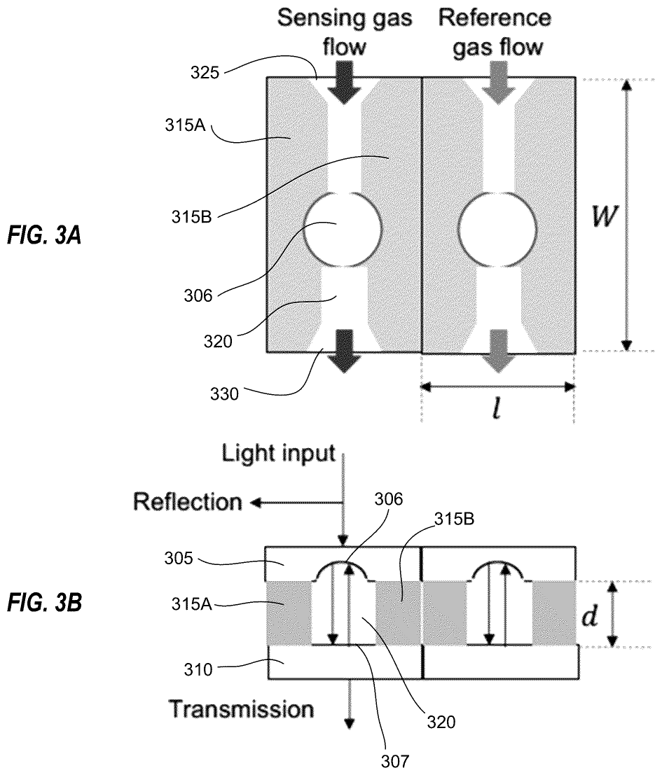

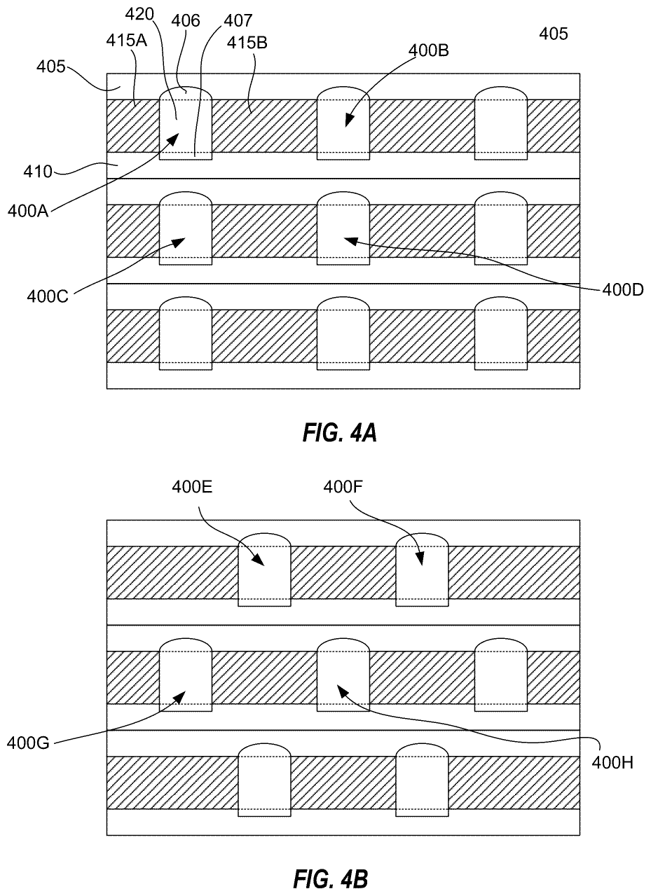

In some embodiments (as shown in FIGS. 3-4), each microchannel can be separated from other microchannels via spacers. In some embodiments, however, as shown in FIG. 2, spacers may not be used between adjacent channels. Similarly, in some embodiments, as shown in FIG. 2, the same planar surfaces 205 210 can include multiple mirrors (e.g., 206A-B) on a single surface (e.g., 205), such that adjacent channels 220 share surfaces 205 210.

FIGS. 3A-B depict another exemplary microcavity system, providing top and side views, respectively. The system shown in FIGS. 3A-B comprises two microchannel unit cells each having substantially identical dimensions. Thus, a reference media (e.g., gas) can flow through one channel while a sensing media flows through the other channel, thus permitting a characterization of the sensing gas based on differences in measurements (light transmission and/or reflection) between the two microcavities. Below, only one of the microchannels is described with reference to numerals on FIGS. 3A-3B.

Each microcavity can comprise a first planar surface 305 having a first mirror 306 and an opposing second planar surface 310 having a second mirror 307. One or more spacers 315A-B can separate the planar surfaces 305 310 thereby defining a channel 320. At one end of the channel 320 is an inlet 325 and at the other end of the channel 320 is an outlet 330. The media/gas can enter then channel through inlet 325, pass through the channel 320 between the opposing mirrors 306 307 while being interrogated with light, and exit the channel 320 through the outlet 330.

FIGS. 4A-B also provide exemplary microcavity systems in the form of microcavity arrays having repeated unit cells. Each unit cell 420A-H can comprise a first surface 406 having a first mirror 407 and an opposing second surface 410 having a second mirror. One or more spacers 415A-B can separate the mirrors 406 407 to thereby define a channel 420. An array can be formed by a plurality of planar rows of cells. For example, as shown in FIG. 4A, cells 400A and 400B can be coplanar to form a first row, and cells 400C and 400D can be coplanar to form a second row. Similarly, in FIG. 4B, cells 400E and 400F can form a first row, and cells 400G and 400H can form a second row. The first and second rows can be staked on top of each other to form an array. Many more cells can form many more rows and rows can include any number of cells, in accordance with various embodiments of the present disclosure. Additionally, in some embodiments the cells can be aligned in a grid as shown in FIG. 4A or in a “honeycomb” alignment as shown in FIG. 4B.

The surfaces/substrates used in embodiments of the present disclosure can be many different materials. In some embodiments, the surfaces can be made of transparent materials such as glass or fused silica.

The mirrors can be etched in the surface/substrates. In some embodiments, the mirrors can have curved/arcuate surfaces, e.g., concave surfaces (e.g., 206A-B, 207, 306, 406). In some embodiments, one or more mirrors can be flat mirrors (e.g., 207B, 307, 407). In some embodiments, the mirrors can be circular. The circular mirrors can have many different diameters in accordance with various embodiments of the present disclosure. In some embodiments, the mirrors can have a diameter of at least 20 microns, at least 50 microns, at least 100 microns, at least 150 microns, at least 200 microns, at least 250 microns, at least 300 microns, at least 350 microns, at least 400 microns, at least 450 microns, at least 500 microns, or at least 550 microns. In some embodiments, the mirrors can have a diameter of less than 600 microns, less than 550 microns, less than 500 microns, less than 450 microns, less than 400 microns, less than 350 microns, less than 300 microns, less than 250 microns, less than 200 microns, less than 150 microns, or less than 100 microns. In some embodiments, the mirrors can have diameters within a range of each of the above upper and lower limits, such as 20-600 microns, 50-600 microns, 150-250 microns, 200-550 microns, and the like.

Similarly, in some embodiments, the mirrors can have many different radii of curvature, in accordance with various embodiments. In some embodiments, the mirrors can have a radius of curvature of at least 300 microns, at least 500 microns, at least 750 microns, at least 1 mm, at least 1.5 mm, at least 1.75 mm, at least 2 mm, at least 2.25 mm, at least 2.5 mm, at least 2.75 mm, at least 3 mm, at least 3.25 mm, at least 3.5 mm, or at least 3.75 mm. In some embodiments, the mirrors can have a radius of curvature of no more than 4 mm, no more than 3.75 mm, no more than 3.5 mm, no more than 3.25 mm, no more than 3 mm, no more than 2.75 mm, no more than 2.5 mm, no more than 2.25 mm, no more than 2 mm, no more than 1.75 mm, no more than 1.5 mm, no more than 1.25 mm, no more than 1 mm, no more than 750 microns, or no more than 500 microns. In some embodiments, the mirrors can have diameters within a range of each of the above upper and lower limits, such as 300 microns to 4 mm, 1-3.5 mm, 1.5-2.75 mm, 500 microns to 1.5 mm, and the like.

Additionally, some embodiments of the present disclosure provide for each unit cell to have different dimensions, particularly in embodiments where the cells are arranged in an array. For example, in the arrangement shown in FIGS. 4A-B, cell 400A can have, for example, a different channel height than cell 400B, and cell 400B can have a different channel width than cell 400D. This can allow for improved measurements of certain analytes by passing the analytes through different channel geometries.

In some embodiments, as shown in FIG. 2, the spacer can be made from a material that allows its thickness to be statically (by machining) or dynamically adjusted to alter a spacing between the first and second mirrors (which alters the path length of light that travels through the cavity. For example, dynamic adjustment can be done with piezoelectric materials, such that a drive signal applied to the piezoelectric spacer can alter a thickness of the spacer, thus altering a distance between the mirrors. As opposed to piezoelectric materials, microheater thermal control can also be used to alter the spacers.

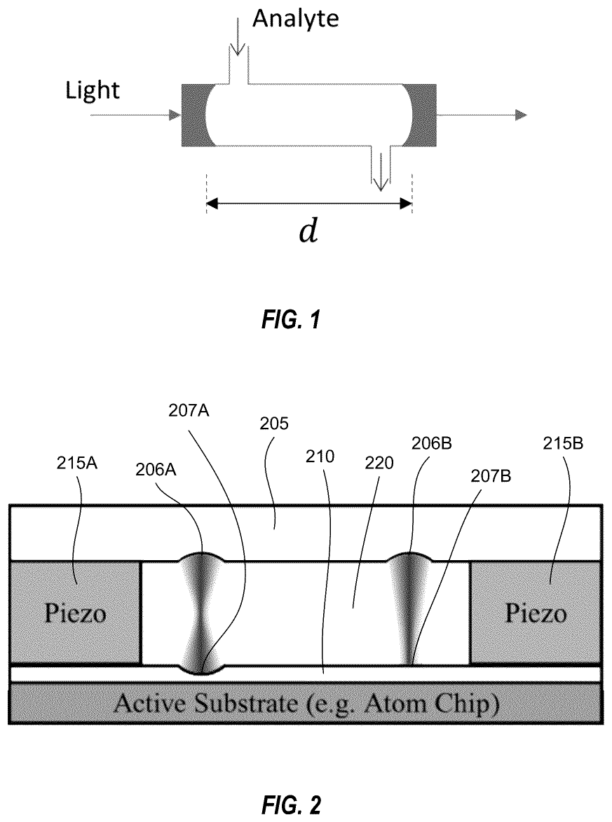

As discussed above, many problems with conventional system is that they were so large (e.g., macroscopic systems shown in FIG. 1) that they suffered from imperfections in the manufacturing process. Additionally some conventional systems had cavity dimensions that were so small (e.g., less than 50 microns) that it was difficult to pass an analyte through the cavity. Accordingly, embodiments of the present disclosure provide optimized cavity dimensions. Dimensions are explained in the context of those labeled in FIGS. 3A-B.

In some embodiments, the channels can have a channel height (“d” in FIG. 3B) of at least 50 microns, at least 100 microns, at least 500 microns, at least 1 mm, at least 1.5 mm, at least 2 mm, at least 2.5 mm, at least 3 mm, or at least 3.5 mm. In some embodiments, the channels can have a channel height of no more than 4 mm, no more than 3.5 mm, no more than 3 mm, no more than 2.5 mm, no more than 2 mm, no more than 1.5 mm, no more than 1 mm, or no more than 500 microns. In some embodiments, the channels can have a channel height within a range of each of the above upper and lower limits, such as 50 microns to 4 mm, 100 microns to 3.5 mm, 500 microns to 1 mm, and the like.

The channels can have a channel width (“1” in FIG. 3A) of at least 100 microns, at least 300 microns, at least 500 microns, at least 1 mm, at least 5 mm, at least 10 mm, at least 15 mm, of at least 20 mm. In some embodiments, the channels can have a channel width of no more than one inch, no more than 20 mm, no more than 15 mm, no more than 10 mm, no more than 5 mm, no more than 1 mm, or no more than 500 microns. In some embodiments, the channels can have a channel width within a range of each of the above upper and lower limits, such as 100 microns to one inch, 300 microns to 1 mm, 500 microns to 20 mm, 1-10 mm, and the like.

The channels can have a channel length (“W” in FIG. 3A) of at least 100 microns, at least 300 microns, at least 500 microns, at least 600 microns, at least 1 mm, at least 5 mm, at least 10 mm, at least 15 mm, of at least 20 mm. In some embodiments, the channels can have a channel length of no more than one inch, no more than 20 mm, no more than 15 mm, no more than 10 mm, no more than 5 mm, no more than 1 mm, or no more than 500 microns. In some embodiments, the channels can have a channel length within a range of each of the above upper and lower limits, such as 100 microns to one inch, 600 microns to 1 mm, 500 microns to 20 mm, 1-10 mm, and the like.

As discussed above, the microcavity systems disclosed herein can be used to sense a characteristic of an analyte using cavity absorption spectroscopy. Thus, some embodiments of the present disclosure provide methods of sensing at least one characteristic of an analyte. In some embodiments, the methods can comprise flowing media with the analyte through one or more microcavities; energizing the microcavity; and sensing at least one of the characteristics of the analyte via interrogation of the energized microcavity.

The media can be any many different forms, including liquid or gaseous.

Energizing the microcavity can comprise lighting the microcavity (e.g., free beam or fiber coupling), such that light reflects between each of the first and second mirrors.

Sensing can comprise comparing one or more properties of light entering the microcavity and light exiting the microcavity (either than transmission or reflection).

### Examples

The examples below further explain certain features of embodiments of the present disclosure. These examples are provided for illustration purposes only and should not be construed as limiting the scope of the present disclosure.

### Microcavity Design

FIG. 2 shows a basic design of a microcavity array of the present disclosure. In particular, FIG. 2 provides a representation of a two-component micro-optical cavity array. This particular array demonstrates how cavities of different types can be integrated into the same structure to take advantage of optical coupling to different physical systems. Mirrors are etched into a transparent substrate such as glass or fused silica, with the cavity length defined by a spacer layer. This layer provides mechanical stability for the cavity, and has gaps etched at the location of the cavity electromagnetic field to allow the sample to enter. Prior art has used cavity lengths much smaller, at most 50 μm where a spacer is not strictly needed. Embodiments disclosed herein, however, can use larger cavity spacings, e.g., in the range of 500 μm to 1 mm, where it is much easier to position the sample within the cavity volume. Nonetheless, the spacing is still considerably smaller than for macroscopic cavities such as shown in FIG. 1 and can reduce the SWaP of the overall device. Another advance is that by utilizing a deliberate spacer layer, the spacer thickness (and therefore, the cavity transmission resonance frequencies) can be controlled at each cavity location independently. Either a piezo control or micro-heater thermal control can be implemented. In one application to cavity quantum electrodynamics, the entire cavity can be placed upon an active substrate (an atom chip) that guides atoms into the respective cavities for detection and quantum processing. In other applications gas or liquid may be flowed into the cavities for detection. The use of an array of micromirrors with different properties allows for different types of chemicals and/or particulate matter to be sensed, and to reduce individual sensor noise by common mode rejection. In these designs light may be delivered to the cavity via a free space beam or through fiber coupling, with either transmission or reflection from the cavities being the mode of detection.

### Exemplary Applications

FIGS. 3A-B show a microcavity implementation of a particle sensor in a compact and scalable architecture. The microcavity array can be used for sensing of heterogeneous particle and/or gas analytes. As shown in FIG. 3A (top view), the micromirror substrates are bonded to a spacer with etched channels that allow the analyte (arrows) to flow through the optical cavity (circle) without adhering to any of its interior surfaces. A reference gas flows into an identical, adjacent sensor. This unit cell can be repeated to create a sensing array (See FIGS. 4A-B for exemplary array implementations). As shown in FIG. 3B (side view), light is input to the micromirror from the top, where it bounces multiple times within the cavity, interacting with the analyte, before exiting. Either transmission or reflection from the cavity may be monitored, and the difference between sensing and reference cavities is recorded. Exemplary dimensions for the cavity shown in FIGS. 3A-B are d=0.5 mm, W≢0.6-1 mm and 1≥0.3 mm, but the disclosure is not so limited, and, as explained above, other embodiments can have differing dimensions.

Several advantages accrue with this design. For one the mirror separation d≈0.5-1 mm is sufficiently small to make the device compact without requiring it to be microscopic. Thus gas can easily flow into and out of the sensor without clogging it. Prior art has used cavity lengths much smaller, at most 50 μm. The shorter cavity allows the use of a single longitudinal mode of transmission, which is beneficial for excitation with a broadband light source as it is more immune to cavity transmission fluctuations. The sensor shown in FIG. 3A-B operates with many finely spaced transmission resonances due to the longer cavity length, and thus the usable optical power is higher. A novel feature of this sensor is the array architecture that allows both sensing and reference gas flows to be located adjacent to one another, thus eliminating most common noise sources including cavity transmission fluctuations, light intensity noise, etc. even while utilizing a broadband light source. Finally, in comparison with planar whispering gallery mode (WGM) resonators where sensing is achieved when particles adhere to or pass very close to the surface where they can irreversibly degrade the sensor, the design shown in FIGS. 3A-B is non-perturbative and allows a long lifetime for its use. The gap allows small particles to flow through the cavity volume without adhering to optical quality surfaces. With steady improvement in reflectivity R, the results are promising for the realization of laboratory quality particle detection in portable devices for personal and environmental health monitoring. A simple extension of the design in FIG. 3 allows for chemical sensing in both liquid and gas phases.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A method of sensing at least one characteristic of an analyte comprising:
flowing media with the analyte through one or more microcavities, each of the one or more microcavities comprising:
a first mirror on a first planar surface;
a second mirror on a second planar surface opposing the first planar surface; and
at least one spacer between the first and second mirrors,
wherein the first mirror, second mirror, and at least one spacer define a channel having an inlet and an outlet, the first and second mirrors positioned between the inlet and outlet;
energizing the microcavity; and
sensing at least one of the characteristics of the analyte via interrogation of the energized microcavity.

2. The method of claim 1, wherein the media is gaseous.

3. The method of claim 1, wherein the media is in liquid form.

4. The method of claim 1, wherein the at least one spacer has a thickness of between 50 microns and 4 mm.

5. The method of claim 1, wherein the one or more microcavities comprises a first microcavity and a second microcavity, wherein the first and second microcavities are coplanar.

6. The method of claim 5, wherein the first microcavity has a first width, a first height, and a first length, wherein the second microcavity as a second width, a second height, and a second length, and wherein at least one or the first width, first height, and first length is different than the second width, second height, and second length, respectively.

7. The method of claim 5, wherein the one or more microcavities further comprises a third microcavity and a fourth microcavity, wherein the third and fourth microcavities are coplanar, and wherein the first and second microcavities are not coplanar with the third and fourth microcavities.

8. The method of claim 1, wherein the first mirror has a concave inner surface.

9. The method of claim 7, wherein the concave inner surface of the first mirror has a radius of curvature of 300 microns to 4 mm.

10. The method of claim 7, wherein the second mirror has a planar inner surface.

11. The method of claim 1, wherein energizing the microcavity comprises lighting the microcavity, such that light reflects between each of the first and second mirrors.

12. The method of claim 6, wherein sensing comprises a comparison of light entering the microcavity and light exiting the microcavity.

13. The method of claim 1, wherein the at least one spacer comprises a piezoelectric material, the method further comprising applying a drive signal to the piezoelectric material to alter a thickness of the at least one spacer.

14. A microcavity system for sensing a characteristic of an analyte, comprising one or more microcavities, each microcavity comprising:
a first planar surface comprising a first mirror;
a second planar surface opposing the first planar surface, the second surface comprising a second mirror,
at least one spacer positioned between the first and second surfaces, the first and second planar surfaces and the at least one spacer defining a channel having an inlet receive the analyte and an outlet configured to eject the analyte.

15. The microcavity system of claim 14, wherein the spacer has a thickness of 50 microns to 4 mm.

16. The microcavity system of claim 14, wherein the first mirror has a concave inner surface.

17. The microcavity system of claim 16, wherein the concave inner surface has a radius of curvature of 300 microns to 4 mm.

18. The microcavity system of claim 14, wherein the one more microcavities comprise a first microcavity and a second microcavity, wherein the first and second microcavities are coplanar.

19. The microcavity system of claim 18, wherein the first microcavity has a first width, a first height, and a first length, wherein the second microcavity as a second width, a second height, and a second length, and wherein at least one or the first width, first height, and first length is different than the second width, second height, and second length, respectively.

20. The microcavity of claim 14, wherein the at least one spacer comprises a piezoelectric material, wherein a thickness of the at least one spacer is adjustable based on a drive signal to the piezoelectric material.
